(19) United States
(12) Patent Application Publication
(10) Pub. No.: US 2026/0171771 A1
(43) Pub. Date: Jun. 18, 2026

(54) CABLE CONVEYANCE RAMP

(71) Applicant: viaPhoton, Inc., Naperville, IL (US)

(72) Inventors: Mark James Smrha, Chicago, IL (US); Mark Van den Avont, Arlington Heights, IL (US); Keith Samuel Maranto, Frankfort, IL (US)

(21) Appl. No.: 19/421,871

(22) Filed: Dec. 16, 2025

Related U.S. Application Data
(60) Provisional application No. 63/734,646, filed on Dec. 16, 2024.

(51) Int. Cl. H02G 3/04

(52) U.S. Cl. CPC H02G 3/0456

(57) ABSTRACT

A cable ramp and associated method and adapter are provided for routing cables from a cable conveyance while maintaining a controlled bend radius. The cable ramp includes a base configured to be mounted adjacent to the cable conveyance and a chute supported from the base by at least one support post. The chute defines a curved cable-guiding path between an entry end adjacent the cable conveyance and an exit end spaced laterally from the cable conveyance, and is shaped such that, when the base is mounted, a tangent of the chute at the exit end is oblique to a longitudinal direction of the cable conveyance. Cables are routed from the conveyance onto the entry end and guided along the curved path to the exit end. An adapter having a lip, floating latch, and catch interfaces with rails and channels of the cable conveyance and receives clips of the cable ramp for removable mounting.

### CROSS-REFERENCE TO RELATED APPLICATIONS

This Application claims the benefit of U.S. Provisional Application Ser. No. 63/734,646, filed Dec. 16, 2024, and entitled “Cable Conveyance Offramp,” which is hereby incorporated by reference for all purposes. This Application also claims the benefit of U.S. Provisional Application Ser. No. 63/811,049, filed May 23, 2025, and entitled “Cable Conveyance Offramp,” which is hereby incorporated by reference for all purposes.

### BACKGROUND

Cable conveyance systems such as wire basket trays, cable ladders, and extruded troughs are widely used in data centers, industrial facilities, and commercial buildings to support and route bundles of communication and power cables. These structures typically extend along a longitudinal path and are mounted near ceilings, walls, or within equipment rows to keep cables organized and elevated. At various points along a run, groups of cables must exit the main conveyance and transition toward racks, cabinets, or other termination locations, often over relatively short distances, and around existing structural constraints.

In many installations, cable exits from these conveyances are created in an ad hoc manner. Installers may route cables over sharp tray edges, through improvised openings, or over fixed brackets that are not designed to manage bend radius or cable loading. Such practices can result in non-compliant bend radii, increased mechanical stress on cable jackets and terminations, and inconsistent cable routing paths. Fixed-direction drop-outs and rigid brackets can also limit where and how exits can be placed, especially when rack positions, aisle layouts, or equipment configurations change over time. As a result, rework and field modification are common when infrastructure is expanded or reconfigured.

Existing accessories for forming cable exits often are tailored to a specific tray type or cross-section, and may require tools, loose hardware, or permanent fasteners for installation. Components designed for one style of conveyance, such as a particular extruded trough profile, may not be compatible with wire basket trays or ladder rungs, leading to multiple product families and added complexity in planning and inventory. In addition, many conventional exit brackets provide only vertical or orthogonal drop paths that do not efficiently manage lateral offsets to target equipment, which can increase congestion and obstruct access in dense cabling environments.

### SUMMARY

In one aspect, a cable ramp is provided for routing cables from a cable conveyance. The cable ramp includes a base configured to be mounted adjacent to the cable conveyance and a chute extending from the base. The chute defines a curved cable-guiding path between an entry end adjacent the cable conveyance and an exit end spaced laterally from the cable conveyance. One or more support posts extend between the base and the chute to support the chute. The chute is curved such that, when the base is mounted to the cable conveyance, a tangent of the chute at the exit end is oblique to a longitudinal direction of the cable conveyance, thereby guiding cables from the cable conveyance along a controlled bend radius.

In another aspect, a method of conveying cables from a cable conveyance is provided. The method includes mounting a base of a cable ramp adjacent to the cable conveyance and supporting a chute of the cable ramp from the base using at least one support post extending between the base and the chute. Cables are routed from the cable conveyance onto an entry end of the chute and guided along a curved cable-guiding path of the chute to an exit end of the chute that is spaced laterally from the cable conveyance. When the base is mounted to the cable conveyance, a tangent of the chute at the exit end is oblique to a longitudinal direction of the cable conveyance such that the cables are routed along a controlled bend radius.

In a further aspect, an adapter is provided for mounting a cable ramp to a cable conveyance. The adapter includes a body configured to be positioned adjacent to the cable conveyance, a lip on the body configured to engage a rail of the cable conveyance, and at least one floating latch coupled to the body and configured to engage at least one channel of the cable conveyance. At least one latch slide movably supports the floating latch to adjust a position of the floating latch relative to the lip to accommodate different cross-sectional geometries of the cable conveyance. The adapter further includes at least one catch on the body configured to receive at least one clip of the cable ramp to removably secure the cable ramp to the adapter.

Other aspects of the invention will be apparent from the following description and the appended claims.

### BRIEF DESCRIPTION OF DRAWINGS

FIG. 1 is an environmental view showing a rack and a cable conveyance in accordance with one or more embodiments of the disclosure.

FIG. 2 is a perspective view of a cable ramp in accordance with one or more embodiments.

FIG. 3A and FIG. 3B are perspective views of the cable ramp mounted adjacent to a cable in accordance with one or more embodiments.

FIG. 4 is a view of the cable ramp and the cable conveyance in accordance with one or more embodiments.

FIG. 5 is a perspective view of an adapter in accordance with one or more embodiments.

FIG. 6A and FIG. 6B are additional views of the adapter in accordance with one or more embodiments.

FIG. 7 is a view of the adapter and the cable ramp in accordance with one or more embodiments.

FIG. 8A and FIG. 8B are additional views of the cable conveyance and the adapter in accordance with one or more embodiments.

FIG. 9A and FIG. 9B are additional views of the adapter, the cable ramp, and the cable conveyance in accordance with one or more embodiments.

FIG. 10 is a flow chart for cable conveyance in accordance with one or more embodiments.

Like elements in the various figures are denoted by like reference numerals for consistency.

### DETAILED DESCRIPTION

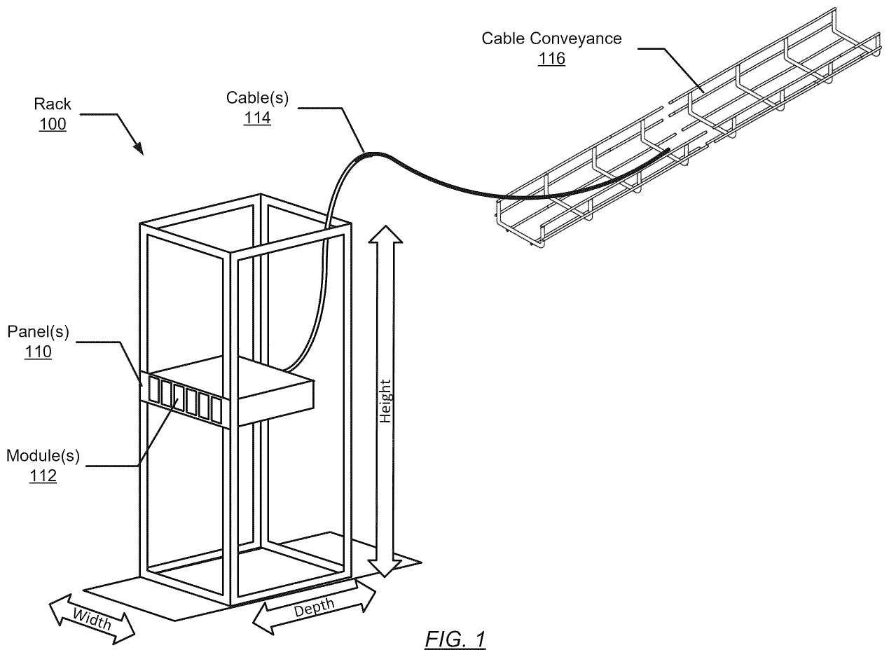

Turning to FIG. 1, a rack is shown in accordance with one or more embodiments. The rack (100) is a piece of telecommunications equipment that provides for the housing and organization of diverse telecommunication devices.

The outer dimensions of rack (100) conform with most network and server equipment. For example, rack width may measure 19 inches (48.26 cm) or 23 inches (58.42 cm) in width, standard measurements that are adhered to in the telecommunications industry. Other dimensions may be used, e.g., 21 inches, 23 inches, etc. The dimensions ensure that the rack can accommodate equipment with different form factors, such as 1 U, 2 U, or larger units, where “U” represents a standard rack unit of measure equal to 1.75 inches in height.

The rack (100) may include a series of uniformly spaced vertical mounting slots, located on both the front and rear, to facilitate the arrangement and mounting of various telecommunication devices and components. The slots serve as attachment points for mounting the panel(s) (110). The rack (100) may further be equipped with additional features such as ventilation openings and cable management.

Panel(s) (110) are components that mount within the rack (100) to organize, secure, and provide access to connective hardware. The panel may be constructed from materials such as steel or aluminum that can support the weight of the modules and withstand the physical demands of a data center environment.

Panel(s) (110) are formed with standardized form factors for compatibility with the mounting slots of the rack (100). For example, panel(s) (110) may include standardized mounting points to align with rack units, a layout that supports the intended cable or connector density, and provisions for labeling and user accessibility.

The panel(s) (110) may be equipped with one or more module(s) (112) to secure the fibers using ports, connector adapters, connectors, etc. Module(s) (112) are prefabricated units or sub-assemblies designed for quick installation into the rack (100). The module(s) (112) may include electronic components and/or optical components, such as optical connectors, optical fibers, switches, routers, or patches. The module(s) (112) may include features for splicing, cable management, and security.

Each module(s) (112) is designed to contain a specific number of optical connectors, optimizing space utilization within the rack mount to support high fiber densities. For example, each module(s) (112) may support fiber densities of 144 fibers, 288 fibers, and/or 576 fibers per module, as well as other suitable densities. The connectors may be an industry-standard connector such as a standard connector (SC), Lucent connector (LC), or Multi-fiber Termination Push-on connector (MTP), depending on the network requirements.

The module(s) (112) may have multiple widths, such that a varying number of modules may be housed within the panel(s) (110). The module(s) (112) may be sized to fit twelve (12) modules in the panel(s) (110), however other sizes—e.g., 2, 3, 4, 6, 8—are also contemplated. When fully loaded with module(s) (112), the panel(s) (110) support fiber densities of 1728 fibers, 3456, fibers, and/or 6912 fibers per panel, as well as other suitable densities.

Cable(s) (114) may be fiber optic cables that carry data signals between different network devices and components. Cable(s) (114) are routed through the data center infrastructure, connecting panels, modules, and external devices. For example, cable(s) (114) may interconnect module(s) (112). Cable(s) (114) may include a core, cladding, and protective coating, which ensure the integrity of the data signal. Cable(s) (114) can be single-mode or multi-mode, depending on the network requirements. Cable(s) (114) may be color-coded to facilitate identification during installation and maintenance.

Cable tray (116) is a support system used to route and support telecommunications and other optical fiber cable. The tray is mounted overhead or along the walls, providing an organized pathway for cables, preventing tangling, and reducing the risk of damage. Cable trays may be equipped with side walls or barriers to constrain a cable's horizontal placement or movement. Cable trays are made from metal or reinforced plastic and are designed to accommodate the weight and volume of multiple cables. Slots or openings in the tray allow for cable entry and exit at various points. Cable trays may include modular segments that can be extended or adjusted to match the infrastructure layout.

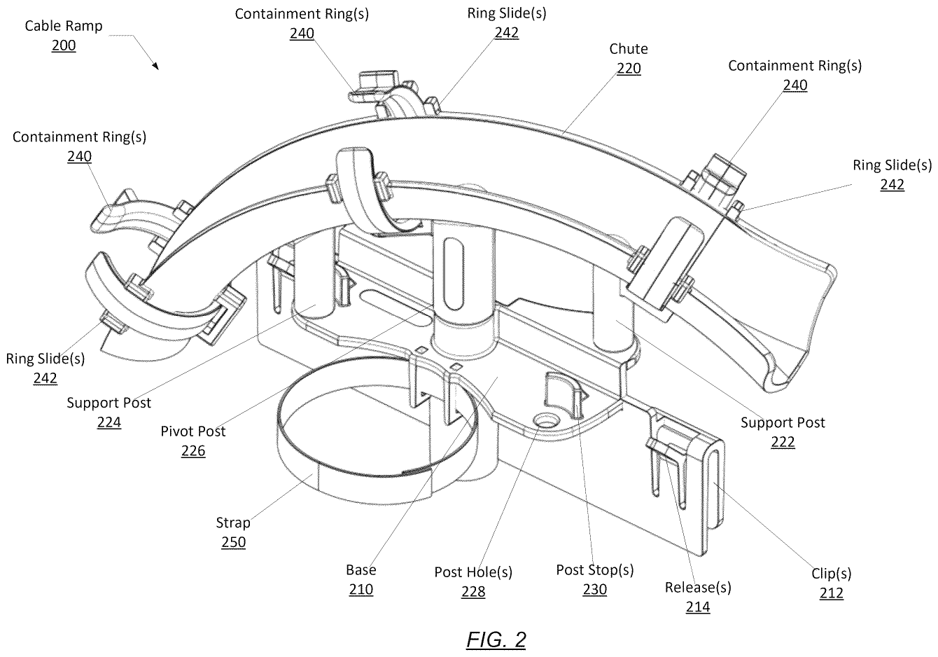

FIG. 2 is a perspective view of a cable ramp including a base, a chute extending from the base, one or more support posts between the base and the chute, and attachment and cable-retention features configured to mount the cable ramp adjacent to a cable conveyance and guide cables along the chute.

FIG. 2 illustrates a cable ramp (200). The cable ramp (200) includes a base (210) and a chute (220) connected by one or more support posts (222, 224). The components are arranged such that the chute (220) extends away from the base (210) along a curved path that is configured to guide cable(s) (114) from an entry region near the base (210) toward an exit region spaced laterally from the base (210). The overall geometry of the cable ramp (200) defines a cable path that transitions between a region adjacent a cable conveyance (116) and a region offset from the cable conveyance (116).

The base (210) provides a mounting structure for the cable ramp (200). In FIG. 2, the base (210) is shown as a body that supports attachment of the support posts (222, 224), a pivot post (226), and one or more clips (212). The base (210) includes one or more post holes (228) that receive ends of the support posts (222, 224) and the pivot post (226). The post holes (228) are positioned to establish the relative spacing and orientation between the base (210) and the chute (220) and to define the location of the cable path relative to the mounting plane of the base (210).

The chute (220) extends from the base (210) and forms a curved cable-guiding structure. In FIG. 2, the chute (220) is shown with a length that curves away from the base (210) so that cable(s) (114) supported on the chute (220) are redirected along a non-linear path. The chute (220) includes an entry region adjacent the base (210) and an exit region that is spaced from the base (210), with intermediate sections configured to maintain a controlled bend radius for cable(s) (114). Side regions of the chute (220) provide lateral boundaries that cooperate with containment elements to retain cable(s) (114) on the chute (220) during installation and use.

The support posts (222, 224) extend between the base (210) and the chute (220) and provide structural support for the chute (220). In FIG. 2, the support posts (222, 224) are shown spaced along the length of the chute (220) to support different portions of the curved structure. The lower ends of the support posts (222, 224) are received in corresponding post holes (228) of the base (210), while the upper ends of the support posts (222, 224) interface with the underside of the chute (220). One or more post stops (230) are associated with the support posts (222, 224) to limit axial or rotational movement of the support posts (222, 224) relative to the base (210), thereby stabilizing the position of the chute (220).

The pivot post (226) also extends between the base (210) and the chute (220). In FIG. 2, the pivot post (226) is received in a corresponding post hole (228) of the base (210) and engages a portion of the chute (220) such that the chute (220) is pivotable relative to the base (210) about the pivot post (226). This pivotable connection allows adjustment of the angular orientation of the chute (220) relative to the base (210), for example to alter the elevation or obliqueness of the exit region of the chute (220). The interaction between the pivot post (226), the post holes (228), and the post stops (230) defines the range of motion and the discrete positions available for the chute (220).

The clip(s) (212) are coupled to the base (210) and provide an attachment mechanism for mounting the cable ramp (200) to a cable conveyance (116) or an adapter (500). In FIG. 2, each clip (212) is shown extending from the base (210) and configured to engage a structural feature of a supporting structure, such as a wire of a wire-frame cable conveyance (116) or a catch (540) of an adapter (500). The clip(s) (212) may include resilient portions that snap into engagement with the supporting structure. One or more release(s) (214) are associated with the clip(s) (212) to allow selective disengagement of the clip(s) (212) from the cable conveyance (116) or the adapter (500), for example by deflecting a portion of the clip (212) to clear the engaged structure.

A plurality of containment rings (240) is positioned around the chute (220). In FIG. 2, the containment rings (240) are arranged along the length of the chute (220) and sized to encircle cable(s) (114) positioned on the chute (220). Each containment ring (240) is mounted to the chute (220) by a corresponding ring slide (242). The ring slides (242) interface with the chute (220) in a manner that allows the containment rings (240) to be translated along the chute (220) to various positions. This arrangement permits the spacing and distribution of the containment rings (240) to be adjusted to accommodate different cable bundle sizes and routing configurations.

A strap (250) is provided to secure cable(s) (114) against the chute (220). In FIG. 2, the strap (250) is shown routed through or around the containment rings (240) so that tension in the strap (250) draws the cable(s) (114) toward the surface of the chute (220). Ends or portions of the strap (250) may be anchored relative to the base (210), the chute (220), or another feature of the cable ramp (200). When tightened, the strap (250) cooperates with the containment rings (240) and the side regions of the chute (220) to maintain the cable(s) (114) in contact with the curved cable-guiding path during deployment or after installation.

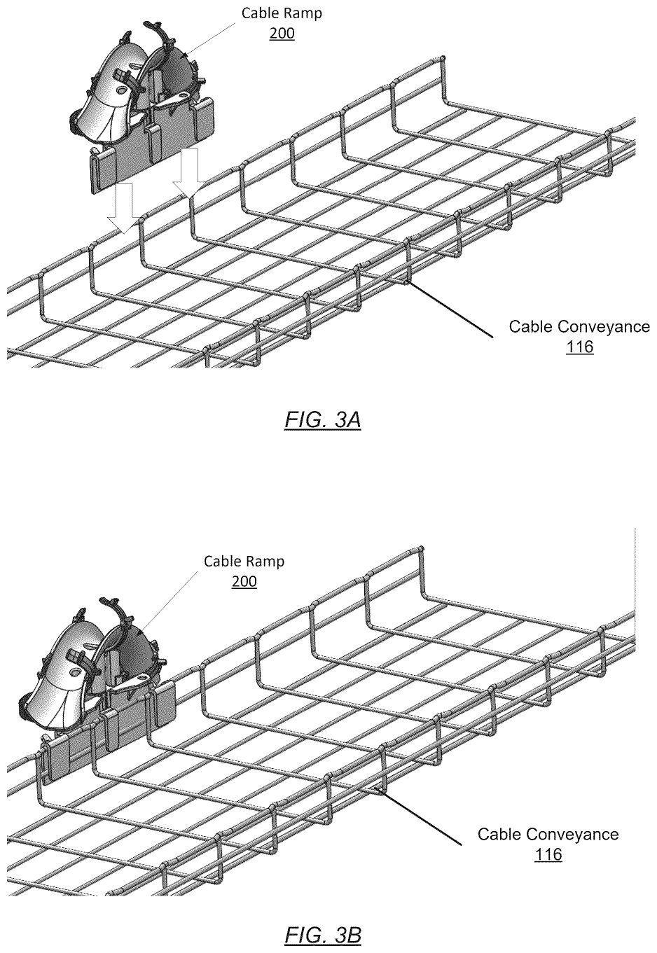

FIGS. 3A and 3B illustrate attachment of a cable ramp (200) to a cable conveyance (116) using a clip (212). In these views, the cable ramp (200) is shown positioned along a side region of the cable conveyance (116), with the clip (212) oriented to engage an outer edge or side wire of the cable conveyance (116). The figures depict the cable ramp (200) in a mounted condition in which the clip (212) secures the cable ramp (200) to the cable conveyance (116) without separate fasteners.

FIG. 3A is a perspective view of a cable ramp adjacent to a cable conveyance and directing cables from the cable conveyance along a curved path. The clip (212) extends from the cable ramp (200) toward the cable conveyance (116). In FIGS. 3A and 3B, the clip (212) is arranged so that an opening or channel of the clip (212) is aligned with a side portion of the cable conveyance (116). During installation, the clip (212) is slid over the side of the cable conveyance (116) so that the side portion of the cable conveyance (116) is received within the opening of the clip (212). As the clip (212) is advanced into position, the clip (212) engages the side of the cable conveyance (116) and constrains relative movement between the cable ramp (200) and the cable conveyance (116)

FIG. 3B is another view of the cable ramp and the cable conveyance illustrating an oblique exit orientation of the cable path relative to a longitudinal direction of the cable conveyance. The cable conveyance (116) in FIG. 3B provides the supporting structure that receives the clip (212). The side of the cable conveyance (116) presents a surface or profile that is compatible with the internal geometry of the clip (212), allowing the clip (212) to be slid into engagement from an open position toward a fully seated position. When the clip (212) is fully seated over the side of the cable conveyance (116), the cable ramp (200) is held adjacent to the cable conveyance (116) in a fixed installed orientation suitable for routing cables from the cable conveyance (116) onto the cable ramp (200).

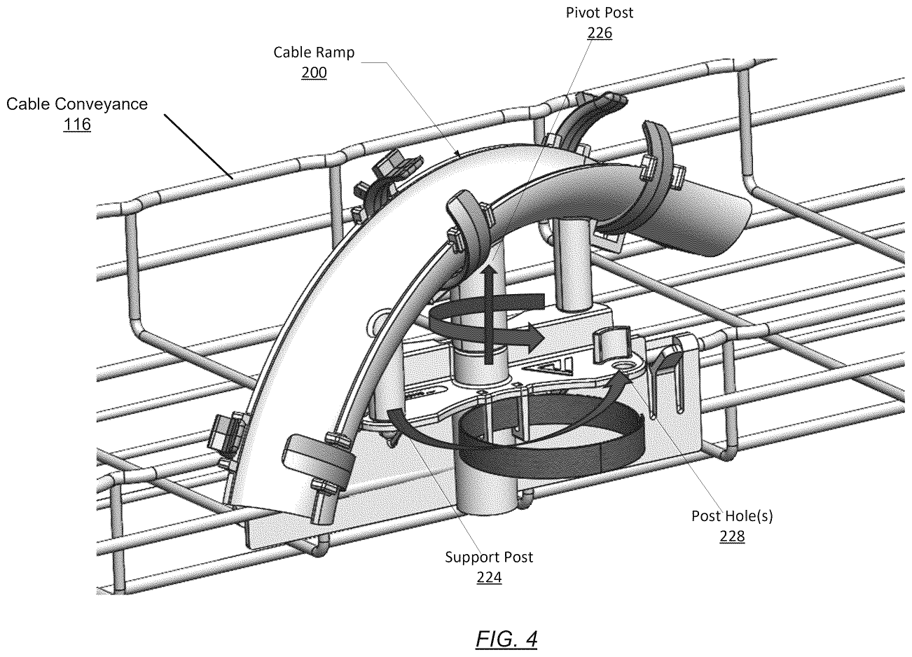

FIG. 4 is a view of the cable ramp and the cable conveyance illustrating a pivot post, a support post, and post holes of a base that cooperate to support and position a chute of the cable ramp relative to the cable conveyance.

FIG. 4 illustrates rotation of a cable ramp (200) relative to a cable conveyance (116) about a pivot post (226). In this view, the cable ramp (200) is shown in different angular positions with respect to the cable conveyance (116), representing alternative exit directions for cables routed from the cable conveyance (116). The figure depicts how the pivotable connection at the pivot post (226) allows the cable ramp (200) to be repositioned between a first orientation and a second orientation on the same mounting location.

The cable conveyance (116) in FIG. 4 provides the structural support from which the cable ramp (200) is suspended. The cable conveyance (116) extends along a longitudinal direction and includes a side region at which the cable ramp (200) is attached. The side region of the cable conveyance (116) establishes a reference for the rotational motion of the cable ramp (200) and defines the location where cables transition from the cable conveyance (116) onto the cable ramp (200).

The cable ramp (200) in FIG. 4 is shown mounted adjacent to the cable conveyance (116) and configured to rotate about the pivot post (226). In one position, the cable ramp (200) extends from the cable conveyance (116) in a first lateral direction, so that cables exiting the cable conveyance (116) are guided along a curved path toward a first side of the cable conveyance (116). In another position, after rotation about the pivot post (226), the cable ramp (200) extends in an opposite lateral direction, so that cables are guided toward an opposite side of the cable conveyance (116). The two positions illustrate that the same cable ramp (200) can provide cable exits in either direction without changing the attachment point on the cable conveyance (116).

The base (210) remains in a fixed relationship with the cable conveyance (116) during rotation of the cable ramp (200). Post holes (228) formed in the base (210) receive the pivot post (226) and may also receive support posts that stabilize the position of the cable ramp (200). The base (210) thereby defines the rotational axis for the cable ramp (200) and maintains the mounting location along the side of the cable conveyance (116).

The chute (220) of the cable ramp (200) is shown extending from the base (210) and rotating with the cable ramp (200) about the pivot post (226). In each illustrated position, the chute (220) defines a curved cable-guiding path that begins adjacent to the cable conveyance (116) and terminates at an exit region spaced laterally from the cable conveyance (116). When the cable ramp (200) is in the first orientation, the chute (220) directs cables toward one lateral side of the cable conveyance (116). When the cable ramp (200) is rotated into the second orientation, the chute (220) directs cables toward the opposite lateral side. The curvature and oblique orientation of the chute (220) relative to the longitudinal direction of the cable conveyance (116) are preserved in both orientations, while the overall exit direction is reversed.

The pivot post (226) is shown in FIG. 4 as extending between the base (210) and a portion of the cable ramp (200), such as the chute (220) or a structural interface coupled to the chute (220). The pivot post (226) is received in the post hole (228) of the base (210) so that the cable ramp (200) can rotate about the axis defined by the pivot post (226). The pivot post (226) permits rotation through an arc sufficient to reposition the cable ramp (200) between at least two discrete exit directions. The pivot post (226) may cooperate with stops or other limiting features (shown in FIG. 2) to define end positions corresponding to the first and second exit orientations.

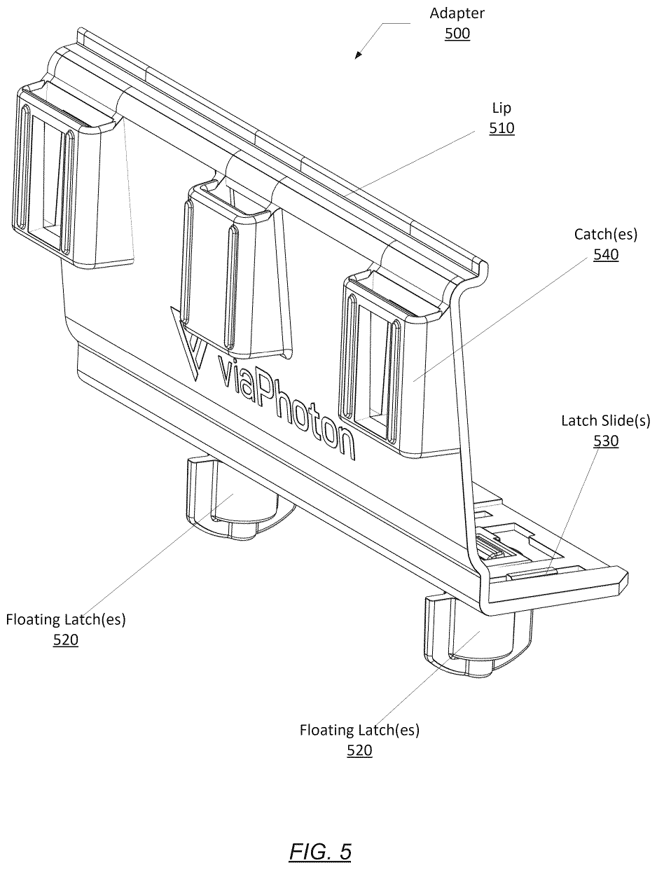

FIG. 5 is a perspective view of an adapter including a body, a lip, one or more floating latches, latch slides, and catches configured to interface with a cable conveyance and to receive clips of a cable ramp.

FIG. 5 illustrates an adapter (500) configured for mounting a cable ramp to a cable conveyance. In this view, the principal components of the adapter (500) include a body, a lip (510), one or more floating latches (520), latch slides (530), and catches (540).

The body of the adapter (500) supports the other components and defines the overall geometry of the adapter (500). The body presents surfaces and edges that establish reference planes for engagement with the cable conveyance and with the cable ramp. Portions of the body carry the lip (510) along one side and the catches (540) along another side, while intermediate regions of the body support the latch slides (530) and the floating latches (520).

The lip (510) extends from an upper region of the body of the adapter (500). In FIG. 5, the lip (510) is arranged along an edge of the body to define a hooked or overhanging profile suitable for engaging a rail of a cable conveyance. The lip (510) provides a first contact region with the cable conveyance, and its position along the body establishes a fixed relationship between the adapter (500) and the rail when the adapter (500) is installed.

The floating latch or latches (520) are shown on a lower or opposite region of the body relative to the lip (510). Each floating latch (520) is positioned to cooperate with the lip (510) so that, when the adapter (500) is mounted, the floating latch (520) engages a channel or recessed feature of the cable conveyance. The floating latch (520) provides a second contact region with the cable conveyance and acts in opposition to the lip (510) to secure the adapter (500) to the cable conveyance.

The latch slides (530) are associated with the floating latches (520) on the body of the adapter (500). In FIG. 5, each latch slide (530) defines a guide structure, such as a track or slot, that movably supports a corresponding floating latch (520). The latch slides (530) permit adjustment of the position of the floating latches (520) relative to the lip (510), for example by translating the floating latches (520) toward or away from the lip (510). This adjustability enables the adapter (500) to accommodate cable conveyances having different cross-sectional geometries.

The catches (540) are located on the body of the adapter (500) at a region configured to face a cable ramp when installed. In FIG. 5, the catches (540) are shown as protruding or recessed engagement features arranged to receive clip(s) of a cable ramp. The spacing and orientation of the catches (540) relative to the lip (510) and the floating latches (520) are selected so that, when the adapter (500) is mounted to the cable conveyance, the catches (540) occupy positions suitable for snap-fit or similar engagement with the clip(s) of the cable ramp.

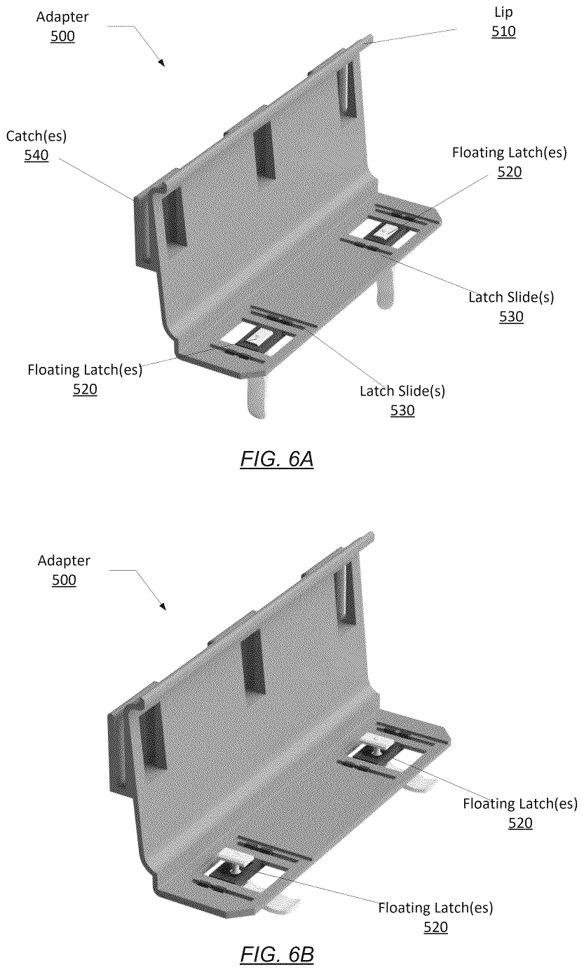

FIG. 6A is a view of the adapter illustrating an arrangement of the lip, the floating latches, and the latch slides relative to the body. FIG. 6B is another view of the adapter showing the floating latches in engagement with the latch slides for adjustment relative to the lip.

FIGS. 6A and 6B illustrate an adapter (500) in greater detail. In these views, the adapter (500) is shown with a body, a lip (510), floating latches (520), and latch slides (530). FIG. 6A emphasizes the relative arrangement of the lip (510), the floating latches (520), and the latch slides (530) on the body of the adapter (500), while FIG. 6B illustrates engagement between the floating latches (520) and the latch slides (530) that enables adjustment of the floating latches (520) relative to the lip (510).

The lip (510) is shown in FIGS. 6A and 6B along an upper edge or side of the body of the adapter (500). The lip (510) extends outward from the body in a direction suitable for engaging a rail or edge feature of a cable conveyance. Its location on the body establishes a first contact region with the cable conveyance and sets a reference distance to which the floating latches (520) are adjusted using the latch slides (530).

The floating latches (520) are shown in FIGS. 6A and 6B positioned along a lower region of the body, spaced from the lip (510). Each floating latch (520) is arranged so that, when the adapter (500) is mounted, the floating latch (520) can engage a channel or recessed feature of the cable conveyance opposite the rail engaged by the lip (510). In FIG. 6A, the floating latches (520) are depicted in relation to the latch slides (530), while FIG. 6B illustrates the floating latches (520) coupled to and supported by the latch slides (530) for guided movement.

The latch slides (530) are shown in FIGS. 6A and 6B as guide structures on the body of the adapter (500) that support the floating latches (520). Each latch slide (530) defines a track, slot, or equivalent guide surface along which the corresponding floating latch (520) can translate. In FIG. 6B, the floating latches (520) are engaged with the latch slides (530) so that movement of the floating latches (520) toward or away from the lip (510) is constrained along defined paths. This engagement permits adjustment of the spacing between the floating latches (520) and the lip (510), allowing the adapter (500) to clamp onto cable conveyances having different rail and channel geometries while maintaining a secure interface between the lip (510), the floating latches (520), and the cable conveyance.

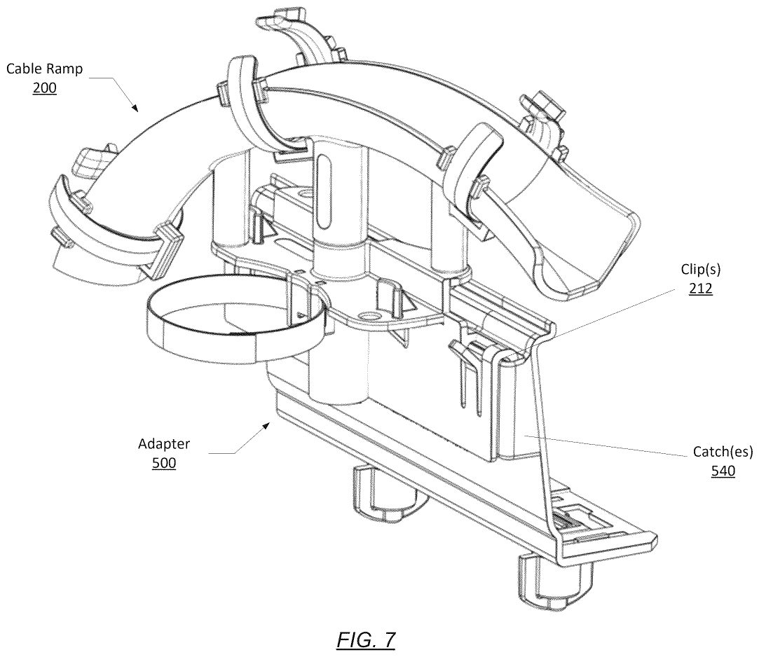

FIG. 7 is a view of the adapter and the cable ramp illustrating clips of the cable ramp engaged with catches of the adapter to mount the cable ramp to the adapter. The adapter (500) in FIG. 7 is shown providing a mounting interface for the cable ramp (200). A region of the adapter (500) facing the cable ramp (200) carries one or more catches (540). The catches (540) are located at positions along the adapter (500) selected to align with corresponding attachment features on the cable ramp (200). The adapter (500) thereby defines engagement points that receive and retain the cable ramp (200) when the cable ramp (200) is installed.

The cable ramp (200) in FIG. 7 includes one or more clips (212) extending from a portion of the cable ramp (200) toward the adapter (500). The clips (212) are oriented such that, when the cable ramp (200) is moved toward the adapter (500), the clips (212) approach the catches (540) along a guided path. The spacing and orientation of the clips (212) on the cable ramp (200) correspond to the spacing and orientation of the catches (540) on the adapter (500) so that each clip (212) is able to engage a respective catch (540).

The catches (540) in FIG. 7 are shown engaged with the clips (212). Each catch (540) receives a portion of a corresponding clip (212), for example by capturing a projecting or recessed portion of the clip (212) within a mating feature of the catch (540). As the cable ramp (200) is pressed toward the adapter (500), the clips (212) move into the catches (540) until the clips (212) are seated. In the seated condition, the interaction between the clips (212) and the catches (540) constrains movement of the cable ramp (200) relative to the adapter (500) and holds the cable ramp (200) in the mounted orientation shown in FIG. 7.

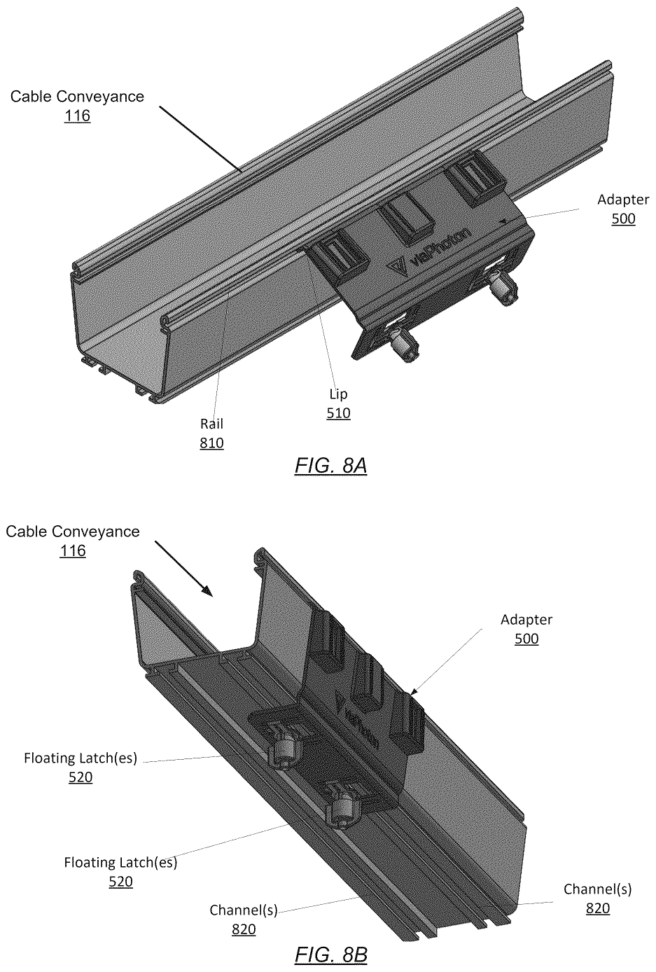

FIG. 8A is a view of a cable conveyance and the adapter illustrating engagement of the lip and the floating latches with rails and channels of the cable conveyance. FIG. 8B is another view of the cable conveyance and the adapter showing additional details of the relationship between the floating latches, the channels, and the lip.

The cable conveyance (116) in FIGS. 8A and 8B defines an extruded or formed structure having the rails (810) and the channels (820) along its side region. Each rail (810) extends along a longitudinal direction of the cable conveyance (116) and forms an outwardly projecting feature usable for mechanical support and for attachment of accessories. The channels (820) are recessed features positioned relative to the rails (810) so that they provide internal engagement surfaces set back from the outer profile of the cable conveyance (116). The spatial relationship between the rails (810) and the channels (820) establishes opposing contact regions for attachment of the adapter (500).

The adapter (500) is shown in FIGS. 8A and 8B positioned along the side of the cable conveyance (116) such that the lip (510) and the floating latches (520) cooperate with the rails (810) and the channels (820). The lip (510) is located at an upper portion of the adapter (500) and extends over or hooks onto one of the rails (810). In the engaged condition, the lip (510) bears against an upper or outer surface of the rail (810), thereby defining a first contact point that supports the adapter (500) from the cable conveyance (116) and locates the adapter (500) in a vertical and lateral sense.

The floating latches (520) are positioned on the adapter (500) to engage the channels (820) of the cable conveyance (116). In FIG. 8A, each floating latch (520) is shown inserted into a corresponding channel (820) so that a portion of the floating latch (520) bears against an internal surface of the channel (820). This engagement provides a second contact region in opposition to the rail (810) engaged by the lip (510). In FIG. 8B, the engagement is shown in greater detail, with the floating latches (520) seated within the channels (820) such that the floating latches (520) resist withdrawal of the adapter (500) away from the side of the cable conveyance (116).

The relationship between the lip (510), the floating latches (520), the rails (810), and the channels (820) is shown in FIGS. 8A and 8B as forming a clamping interface. The lip (510) captures the rail (810) from one side, while the floating latches (520), adjusted into position using associated latch slides (530), bear against the channels (820) from an opposite side. When the adapter (500) is in the installed position, the contact forces between the lip (510) and the rail (810) and between the floating latches (520) and the channels (820) secure the adapter (500) to the cable conveyance (116) without separate fasteners, and position the adapter (500) so that other features of the adapter (500) are available to receive and support a cable ramp.

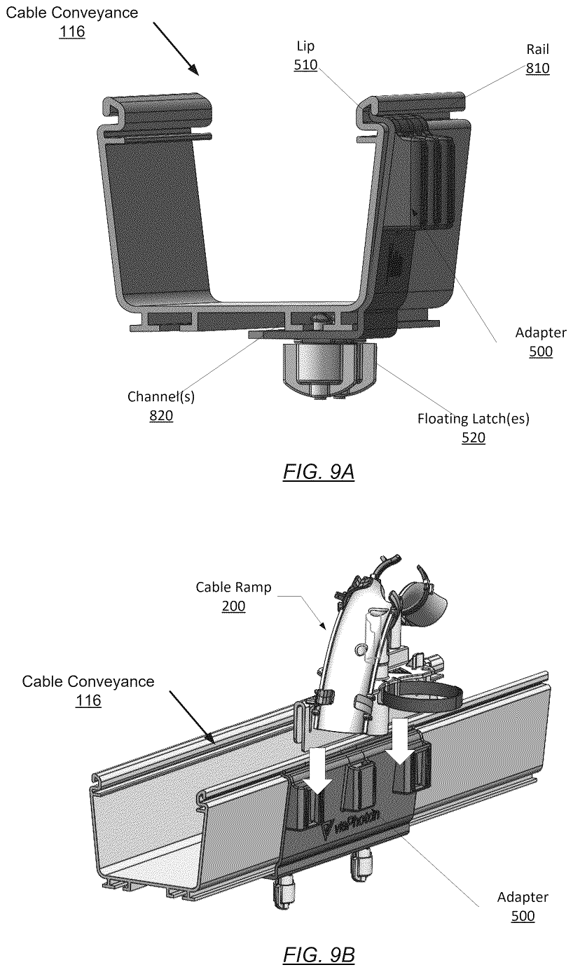

FIG. 9A is a view of the adapter mounted to the cable conveyance, further illustrating rails and channels of the cable conveyance and positions of the floating latches and the lip. FIG. 9B is a view of the adapter, the cable ramp, and the cable conveyance illustrating the cable ramp supported by the adapter on the cable conveyance.

In FIG. 9A, the adapter (500) is shown attached along a side region of the cable conveyance (116). The cable conveyance (116) includes rails (810), and channels (820) as described in connection with FIGS. 8A and 8B. The lip (510) of the adapter (500) is positioned over one of the rails (810), with the lip (510) bearing against a surface of the rail (810) to establish a first contact region. The floating latches (520) are located within the channels (820) so that each floating latch (520) engages an interior surface of a corresponding channel (820). The positions of the lip (510) and the floating latches (520) in FIG. 9A illustrate the clamping relationship that holds the adapter (500) on the cable conveyance (116) by acting on opposing features of the rails (810) and the channels (820).

FIG. 9B shows the adapter (500) supporting the cable ramp (200) on the cable conveyance (116). In this view, the adapter (500) remains mounted to the cable conveyance (116) with the lip (510) engaged with the rail (810) and the floating latches (520) engaged with the channels (820) as in FIG. 9A. The cable ramp (200) is attached to a side of the adapter (500) facing away from the cable conveyance (116), with clips (212) of the cable ramp (200) engaged with corresponding catches (540) on the adapter (500). The engagement between the clips (212) and the catches (540) secures the cable ramp (200) to the adapter (500) so that the cable ramp (200) is supported from the cable conveyance (116) through the adapter (500). The combined arrangement shown in FIG. 9B illustrates how the rails (810), channels (820), lip (510), and floating latches (520) cooperate to fix the adapter (500) to the cable conveyance (116), while the catches (540) and clips (212) provide a detachable interface between the adapter (500) and the cable ramp (200).

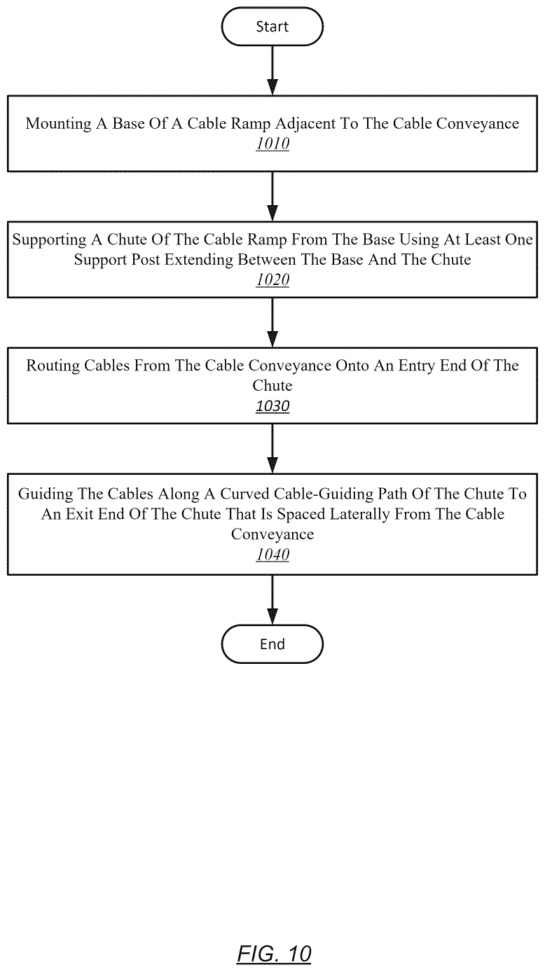

FIG. 10 illustrates a flowchart of a process for conveying cables from a cable conveyance using a cable ramp. The flow proceeds from an initial start state through a sequence of four operations and then to an end state. Each operation corresponds to a functional step that may be conducted during installation or reconfiguration of a cable routing path.

In step 1010, a base of a cable ramp is mounted adjacent to the cable conveyance. In one implementation, the base is positioned near a side region of the cable conveyance and one or more clips on the base are engaged with a structural member of the cable conveyance, such as a side wire or rail, to provide toolless attachment. In another implementation, the base is mounted to an adapter that has been previously secured to the cable conveyance, with clips on the base engaging catches on the adapter so that the adapter functions as an intermediate mounting interface. In either case, the base is fixed in a position that defines where cables will transition from the cable conveyance onto the cable ramp.

In step 1020, a chute of the cable ramp is supported from the base using at least one support post extending between the base and the chute. The support post is received by a corresponding feature on the base and engages the underside of the chute to hold the chute in a defined orientation relative to the base and the cable conveyance. Additional support posts may be used to distribute loading along the length of the chute. In some embodiments, a pivot post is also engaged between the base and the chute so that the chute can be rotated about the pivot post to adjust the exit direction or elevation while remaining supported.

In step 1030, cables are routed from the cable conveyance onto an entry end of the chute. Cables extending along the cable conveyance are brought to the mounting location of the cable ramp and transitioned over the side region of the cable conveyance onto the entry region of the chute. The cables are placed on the cable-guiding surface of the chute so that they are captured and able to follow the curved path defined by the chute as they move toward the exit end.

In step 1040, the cables are guided along a curved cable-guiding path of the chute to an exit end of the chute that is spaced laterally from the cable conveyance. As the cables follow the contour of the chute from the entry end to the exit end, the chute redirects the cables vertically and laterally. The curvature of the chute is selected such that, when the base is mounted to the cable conveyance, a tangent of the chute at the exit end is oblique to a longitudinal direction of the cable conveyance. This geometric relationship causes the cables to leave the cable conveyance at an oblique orientation while maintaining a controlled bend radius determined by the curvature of the chute, thereby keeping the cable bend above a desired minimum radius as the cables reach the laterally offset exit location.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A cable ramp comprising:
a base configured to be mounted adjacent to a cable conveyance;
a chute extending from the base and defining a curved cable-guiding path between an entry end adjacent the cable conveyance and an exit end spaced laterally from the cable conveyance; and
at least one support post extending between the base and the chute to support the chute;
wherein the chute is curved such that, when the base is mounted to the cable conveyance, a tangent of the chute at the exit end is oblique to a longitudinal direction of the cable conveyance to guide cables from the cable conveyance along a controlled bend radius.

2. The cable ramp of claim 1, further comprising:
a pivot post extending between the base and the chute and received in at least one post hole of the base such that the chute is pivotable relative to the base about the pivot post.

3. The cable ramp of claim 2, wherein the base further comprises:
at least one post hole configured to receive the at least one support post to inhibit rotational movement of the pivot post relative to the base.

4. The cable ramp of claim 3, further comprising:
at least one post stop configured to limit at least one of axial movement or rotational movement of the at least one support post relative to the base.

5. The cable ramp of claim 1, further comprising:
a plurality of containment rings positioned around the chute and configured to retain cables on the chute.

6. The cable ramp of claim 5, wherein each containment ring is mounted to the chute by a corresponding ring slide that is slidable along a length of the chute to adjust a position of the containment ring.

7. The cable ramp of claim 1, further comprising:
at least one clip coupled to the base and configured for toolless attachment of the cable ramp to one of the cable conveyance or an adapter.

8. The cable ramp of claim 7, further comprising:
at least one release configured to detach the at least one clip from the cable conveyance or the adapter.

9. The cable ramp of claim 7, wherein the at least one clip comprises a resilient arm configured to snap onto a structural member of a wire-frame cable conveyance for toolless installation and removal.

10. The cable ramp of claim 7, wherein the at least one clip is configured to engage at least one catch of the adapter such that the cable ramp is removably secured to the adapter.

11. The cable ramp of claim 7, further comprising a strap configured to secure cables against the chute during cable deployment.

12. A method of conveying cables from a cable conveyance, the method comprising:
mounting a base of a cable ramp adjacent to the cable conveyance;
supporting a chute of the cable ramp from the base using at least one support post extending between the base and the chute;
routing cables from the cable conveyance onto an entry end of the chute; and
guiding the cables along a curved cable-guiding path of the chute to an exit end of the chute that is spaced laterally from the cable conveyance,
wherein, when the base is mounted to the cable conveyance, a tangent of the chute at the exit end is oblique to a longitudinal direction of the cable conveyance such that the cables are routed along a controlled bend radius.

13. The method of claim 12, further comprising:
pivoting the chute relative to the base about a pivot post extending between the base and the chute and received in at least one post hole of the base to adjust at least one of a height or an angle of the exit end of the chute.

14. The method of claim 12, further comprising:
positioning a plurality of containment rings along the chute and securing the cables against the chute by tightening a strap routed through or around the containment rings.

15. The method of claim 12, wherein mounting the base comprises:
engaging at least one clip coupled to the base with one of a structural member of the cable conveyance or a catch of an adapter mounted to the cable conveyance to provide toolless attachment of the cable ramp.

16. The method of claim 15, further comprising:
actuating at least one release to detach the at least one clip from the cable conveyance or from the adapter.

17. An adapter for mounting a cable ramp to a cable conveyance, the adapter comprising:\
a body configured to be positioned adjacent to the cable conveyance;
a lip on the body configured to engage a rail of the cable conveyance;
at least one floating latch coupled to the body and configured to engage at least one channel of the cable conveyance;
at least one latch slide movably supporting the at least one floating latch to adjust a position of the floating latch relative to the lip to accommodate different cross-sectional geometries of the cable conveyance; and
at least one catch on the body configured to receive at least one clip of the cable ramp to removably secure the cable ramp to the adapter.

18. The adapter of claim 17, wherein the at least one floating latch comprises:
a pair of floating latches spaced apart along a length of the body to engage corresponding channels of the cable conveyance.

19. The adapter of claim 17, wherein each latch slide defines an elongated slot or track permitting translation of the corresponding floating latch toward or away from the lip to clamp onto cable conveyances having different rail and channel dimensions.

20. The adapter of claim 17, wherein the cable conveyance comprises:
an extruded cable trough having the rail and the channels formed as part of an asymmetric cross-section, and
wherein the at least one floating latch includes a contact surface configured to bear against a surface within the channels when the lip is engaged with the rail, thereby clamping the adapter to the cable conveyance without separate fasteners.
